(19) United States
(12) Patent Application Publication
(10) Pub. No.: US 2008/0144829 A1
(43) Pub. Date: Jun. 19, 2008

(54) WIRELESS TAG, WIRELESS TAG READER, DECRYPTOR, METHOD FOR CONTROLLING WIRELESS TAG AND METHOD FOR MANAGING WIRELESS TAG

(75) Inventors: Madoka MITSUOKA, Kawasaki (JP); Masatomo YASAKI, Kawasaki (JP); Mitsuru ODA, Kawasaki (JP); Yasuhide MATSUMOTO, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/954,427

(22) Filed: Dec. 12, 2007

(30) Foreign Application Priority Data
Dec. 14, 2006 (JP) 2006-337508

(51) Int. Cl. H04L 9/32

(52) U.S. Cl. 380/270

(57) ABSTRACT

According to an aspect of the embodiment, a wireless tag which outputs information through a communication part in response to a command of a controlling part. The wireless tag has a storage part which stores a plurality of encrypted identifications. The wireless tag has an output part outputting an identification which has not been output yet, of the identification stored in said storage part, out of the identifications stored in the storage part, when a request for outputting the identification is externally transmitted, through said communication part in accordance with said controlling part. The wireless tag includes a restricting part, which restricts an output of the encrypted identification stored in said storage part in accordance with said controlling part when said output part has output all of the identification stored in said storage part.

### FIELD OF THE INVENTION

The present invention relates to a wireless tag which sends and receives information through a communication unit in response to a command of a controlling unit, and more particularly, to a wireless tag or the like which stores encrypted identification and restricts output of identification when all encrypted identifications are output.

### SUMMARY OF THE INVENTION

A first aspect of the present is a wireless tag. The wireless tag has a storage part storing a plurality of encrypted identifications. The wireless tag has an output part outputting an identification which has not been output yet through a communication part, out of the identifications stored in the storage part, when a request for outputting identification which is externally transmitted is received. The wireless tag has a restricting part restricting output of the encrypted identification stored in the storage part, when the output part has output all of the identifications stored in the storage part.

A second aspect of the present is a wireless tag reader. A wireless tag reader has a first receiving part receiving an encrypted identification output from a wireless tag. The wireless tag reader has a first output part outputting the encrypted identification received by the first receiving part and a user identification for identifying a user of the wireless tag. The wireless tag reader has a second receiving part receiving decrypted identification corresponding to the encrypted identification output by the first output part. The wireless tag reader has a second output part outputting the decrypted identification received by the second receiving part.

A third aspect of the present is a decryptor. The decryptor has a receiving part receiving encrypted identification and a user identification output from a tag reader. The decryptor has a counting part counting a number of times of receiving user identifications. The decryptor has a decrypting part decrypting the received encrypted identification. The decryptor has an output part outputting the identification decrypted by the decrypting part to the wireless tag reader.

A fourth aspect of the present is a storage medium stored with a program for operating a computer provided with a function for sending/receiving information to/from a wireless tag and for causing the computer to execute processes. The storage medium includes a process of receiving an encrypted identification output from a wireless tag. The storage medium includes a process of outputting the received encrypted identification and a user identification for identifying a user of the wireless tag. The storage medium includes a process of receiving the decrypted identification corresponding to the output encrypted identification. The storage medium includes a process of outputting the received decrypted identification.

A fifth aspect of the present is a storage medium stored with a program for operating a computer including a function for sending/receiving information to/from a wireless tag reader and for causing the computer to execute processes. The storage medium includes a process of receiving encrypted identification and a user identification output from the wireless tag reader. The storage medium includes a process of counting a number of times of receiving the user identifications. The storage medium includes a process of decrypting the received encrypted identification. The storage medium includes a process of outputting the decrypted identification to the wireless tag reader.

### BRIEF DESCRIPTION OF THE DRAWINGS

FIG. 1 is an exemplary diagram schematically showing a management system for a wireless tag according to the invention;

FIG. 2 is a block diagram showing a hardware configuration of the wireless tag;

FIG. 3 is a flowchart showing a procedure of an outputting process for an encrypted product code of the wireless tag;

FIG. 4 is a block diagram showing a hardware configuration of a reader and a decryptor;

FIG. 5 is an explanatory diagram showing a record layout for a user ID file;

FIG. 6 is an explanatory diagram showing a record layout for a “unit price/charge (for using the tag) file”;

FIG. 7 is a flowchart showing a sending/receiving process between a reader and a server computer;

FIG. 8 is a flowchart showing a sending/receiving process between the reader and the server computer;

FIG. 9 is a block diagram showing a hardware configuration of a reader and decryptor according to a second embodiment;

FIG. 10 is a block diagram showing a hardware configuration of an information processor;

FIG. 11 is a flowchart showing a procedure of a decrypting/counting process according to the second embodiment;

FIG. 12 is a flowchart showing a procedure of a decrypting/counting process according to the second embodiment;

FIG. 13 is a block diagram showing a hardware configuration of a wireless tag according to a third embodiment;

FIG. 14 is a flowchart showing a procedure of an outputting process of an encrypted product code of a wireless tag;

FIG. 15 is a block diagram showing a hardware configuration of a reader and decryptor according to the third embodiment; and

FIG. 16 is a flowchart showing a sending/receiving process between a reader and a server computer.

### DETAILED DESCRIPTION OF INVENTION

### First Embodiment

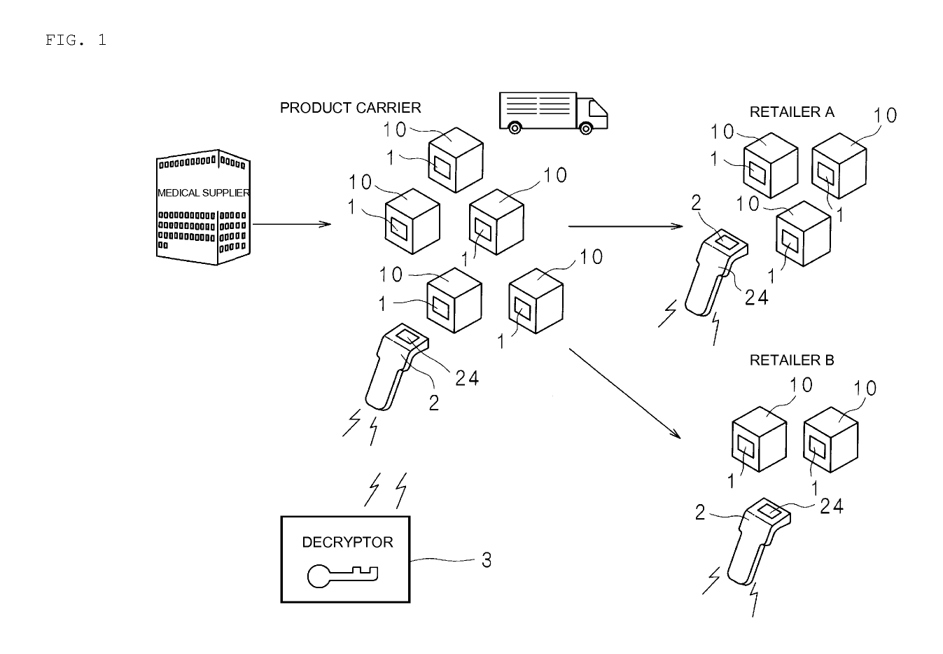

Different embodiments of the invention will now be described with reference to the drawings. FIG. 1 is an exemplary diagram schematically showing a management system for a wireless tag according to the invention. The discussion below describes a wireless tag attached to medical products, by way of example. The following embodiment is exemplary only and is not intended to be limiting. The management system includes a wireless tag 1 attached to a medical product 10, a wireless tag reader (hereinafter, referred to as a “reader”) 2 which sends and receives information to and from the wireless tag 1, and a decryptor 3 which sends and receives information to and from the reader 2. A medical supplier attaches wireless tags 1 onto the respective medical products 10. The wireless tags 1 encrypt and store an identification, which is unique for each specific medical product. In this embodiment, descriptions will be made to an example wherein a label-like passive wireless tag (RFID: Radio Frequency Identification) 1 is attached to a medical product 10. The wireless tag may have a card-like form, a stick-like form, a coin like form or the like. The wireless tag may be an active wireless tag 1.

The medical supplier orders a product carrier for delivery of the medical products 10 attached with the wireless tags 1. The product carrier reads the wireless tags 1 using the reader 2 in order to deliver the medical products 10 to a retailer A and a retailer B. As will be described later, the wireless tag 1 stores the encrypted identification, and outputs only unread identification to the reader 2. The reader 2 receives the encrypted identification from the wireless tag 1. The reader 2 sends the received identification and user identification for specifying a product carrier, to the decryptor 3. The decryptor 3 decrypts the encrypted identification. The decryptor 3 sends the decrypted identification to the reader 2. The reader 2 displays the decrypted identification on a display unit 24.

The product carrier reads the wireless tags 1, respectively attached to all medical products 10, to be delivered, using the reader 2. The decryptor 3 implements a decrypting process, and counts the number of times the tag has been read, in association with user identification. The decryptor 3 multiplies the obtained number of times and the unit price so as to calculate the charge corresponding to the product carrier. The product carrier delivers the medical products 10, to the retailers A and B. The retailer A reads the wireless tags 1, in order to sell the delivered medical products 10, using the reader 2. The wireless tags 1 output encrypted identification which is different from the identification output to the reader 2 of the product carrier.

The reader 2 sends the encrypted identification and the user identification for specifying the retailer A, to the decryptor 3. The decryptor 3 counts the number of times of use based on the user identification. The decryptor 3 multiples the number of times of use and the unit price so as to calculate the charge for using the wireless tag 1, in association with the retailer A. The decryptor 3 sends the decrypted identification to the reader 2 of the retailer A. The reader 2 of the retailer A displays the decrypted identification on the display unit 24. The medical products 10, 10 are also delivered to the retailer B. In a similar procedure described above, the decryptor 3 obtains the charge for using the wireless tag, for the retailer B, while the reader 2 displays the decrypted identification on the display unit 24.

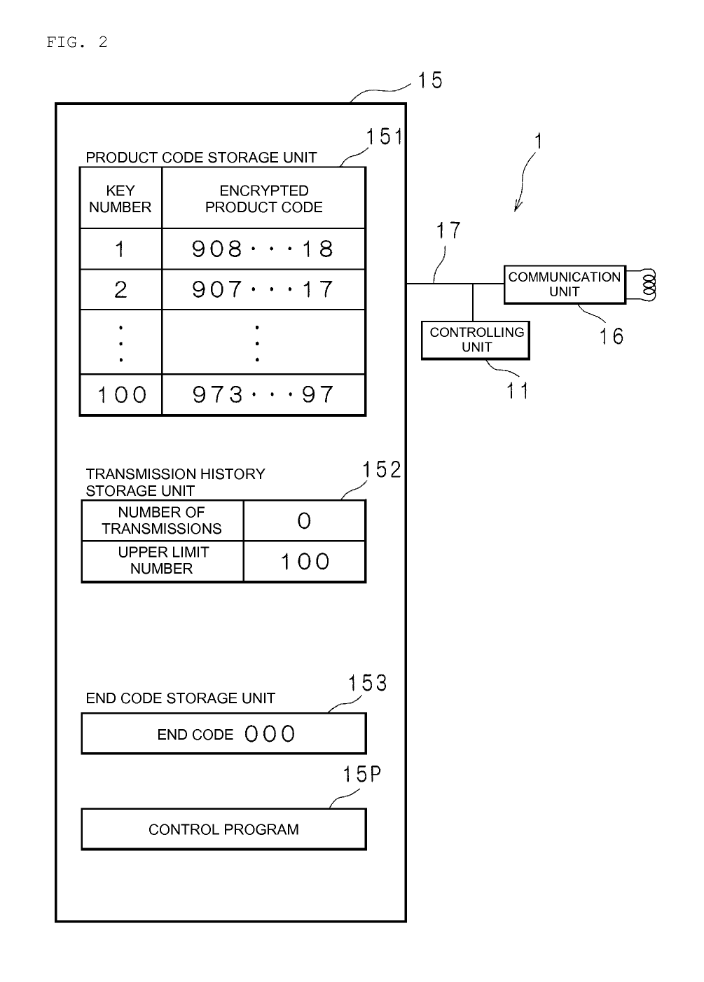

The wireless tag 1 will now specifically be described. FIG. 2 is a block diagram showing a hardware configuration of the wireless tag 1. The wireless tag 1 includes a controlling unit 11, a communication unit 16 and a storage unit 15. The controlling unit 11 is a logic circuit or the like, which controls the communication unit 16 and the storage unit 15 which are connected through a transmission line 17, in accordance with a control program 15P stored in the storage unit 15. The communication unit 16 sends the encrypted identification and the like to the reader 2, using a coil and an RF circuit for wireless communications.

The storage unit 15 may be an EEPROM (Electronically Erasable and Programmable Read Only Memory), FeRAM (Ferroelectric Random Access Memory), ROM, or the like. The storage unit 15 includes a product code storage unit 151, a sending history storage unit 152, the control program 15P and an end code storage unit 153. The product code storage unit 151 includes fields of “key number” and “encrypted product code”. The field of “key number” stores a key number corresponding to a key for decrypting the encrypted identification (hereinafter, referred to as “encrypted product code”). In the example of FIG. 2, one hundred key numbers (i.e. key number from 1 to key number 100) are stored in the fields of “key number”. The field of “encrypted product code” stores an encrypted product code in association with a key number. The manager, who manages identification (hereinafter, referred to as “product code”) of medical suppliers and the like, writes a key number and an encrypted product code into the product code storage unit 151 of the storage unit 15, using a writer (not illustrated).

The sending history storage unit 152 stores the number sent and the upper limit number. The upper limit number corresponds to the number of the key numbers. That is, the value of the upper limit number is equal to the total number of the encrypted product codes. In this example, the upper limit number is 100, and the initial value of the number sent is 0. When the wireless tag 1 receives a request for outputting an encrypted product code from the reader 2, the controlling unit 11 reads the encrypted product code out of the product code storage unit 151 in response to the request for outputting. The controlling unit 11 increments the number sent, every time it reads the encrypted product code out of the product code storage unit 151.

The end code storage unit 153 stores an end code, which is different information from the encrypted product code. In this embodiment, the unit 153 stores “000” as the end code. The manager writes the upper limit number and the end code into the sending history storage unit 152, using the writer. When the controlling unit 11 receives a request for outputting an encrypted product code from the reader 2 through the communication unit 16, it reads the encrypted product codes in the product code storage unit 151 in the order of key number, and outputs the read key numbers and encrypted product codes to the reader 2 through the communication unit 16. The controlling unit 11 increments the number sent stored in the sending history storage unit 152.

Upon reception of a request for outputting an encrypted product code from the reader 2 through the communication unit 16, the controlling unit 11 reads an encrypted product code which has not yet been output out of the product code storage unit 151. That is, the controlling unit 11 reads a key number corresponding to a value obtained by adding one to the number sent that is stored in the sending history storage unit 152 and also an encrypted product code corresponding to the key number. Then, the unit 11 sends the read information to the reader 2 through the communication unit 16. The controlling unit 11 increments the number sent stored in the sending history storage unit 152.

By repeating the above procedure, the controlling unit 11 of the wireless tag 1 outputs all encrypted product codes to the reader 2. The number sent reaches the upper limit number, “100”. Then, the controlling unit 11 of the wireless tag 1 outputs from the first key number 1 and an encrypted product code corresponding to the first key number 1 up to the last key number 100 and an encrypted product code corresponding to the last key number 100, sequentially to the reader 2 through the communication unit 16. After that, upon reception of a request for outputting an encrypted product code from the reader 2, the controlling unit 11 implements a process for restricting the output of the encrypted product code. That is, if the controlling unit 11 determines that the number sent has reached the upper limit, it reads the end code stored in the end code storage unit 153, and sends the read end code to the reader 2 through the communication unit 16.

By so doing, the sending restriction of the encrypted product code can be done. In this embodiment, the descriptions have been made to the example sent the end code that differs from the encrypted product code. However, as long as the sending of the encrypted product code can successfully be restricted, any other process can be implemented. For example, upon reception of the request for outputting the encrypted product code from the reader 2, the controlling unit 11 may output no information, thereby restricting the output of the encrypted product code. In this case, the reader 2 can understand that the output of the encrypted product code of the wireless tag 1 is restricted due to a time-out.

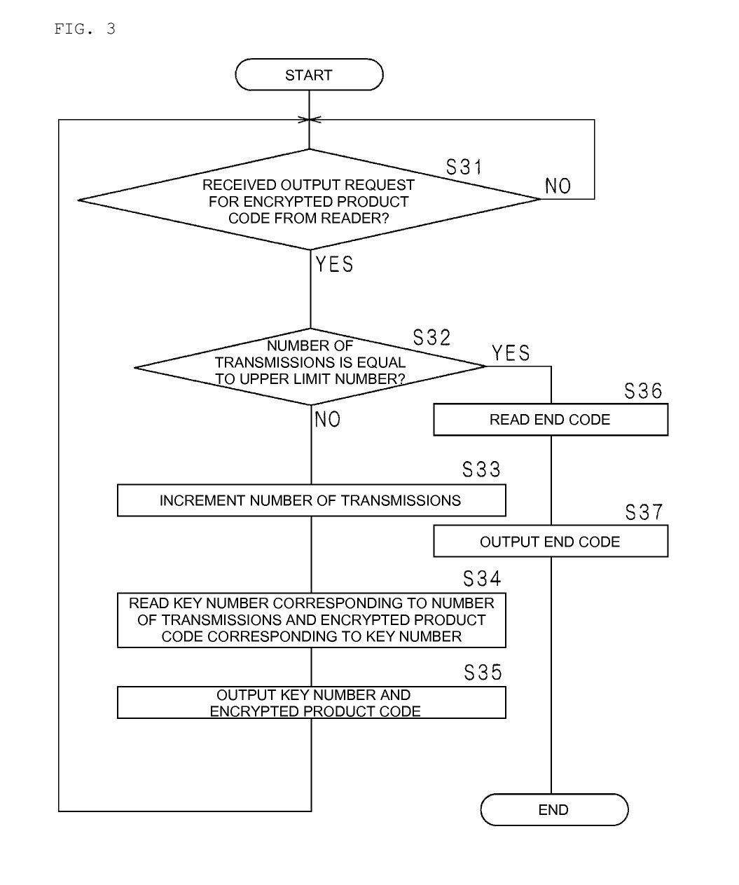

FIG. 3 is a flowchart showing a procedure of a process for outputting an encrypted product code of the wireless tag 1. The controlling unit 11 determines whether a request for outputting the encrypted product code is received from the reader 2 (Step S31). When determined that the request for outputting the encrypted product code has not been received from the reader 2 (NO in Step S31), the controlling unit 11 waits until the request for outputting will be received. On the contrary, when determined that the request for outputting the encrypted product code has been received from the reader 2 (YES in Step S31), the controlling unit 11 refers the sending history storage unit 152 in order to determine whether the number sent is equal to the upper limit number (Step S32).

When determined that the number sent does not reach the upper limit number (NO in Step S32), the controlling unit 11 increments the number sent which is stored in the sending history storage unit 152 (Step S33). The controlling unit 11 reads a key number corresponding to the number sent in the sending history storage unit 152 and also an encrypted product code corresponding to this key number out of the product code storage unit 151 (Step S34). The controlling unit 11 outputs the read key number and encrypted product code to the reader 2 through the communication unit 16 (Step S35). Then, the controlling unit 11 moves to Step S31 and repeats the above steps.

If the number sent in the sending history storage unit 152 is equal to the upper limit number (YES in Step S32), the controlling unit 11 reads the end code out of the end code storage unit 153 because all of the one hundred encrypted product codes have already been output (Step S36). The controlling unit 11 outputs the read end code to the reader 2 through the communication unit 16 (Step S37).

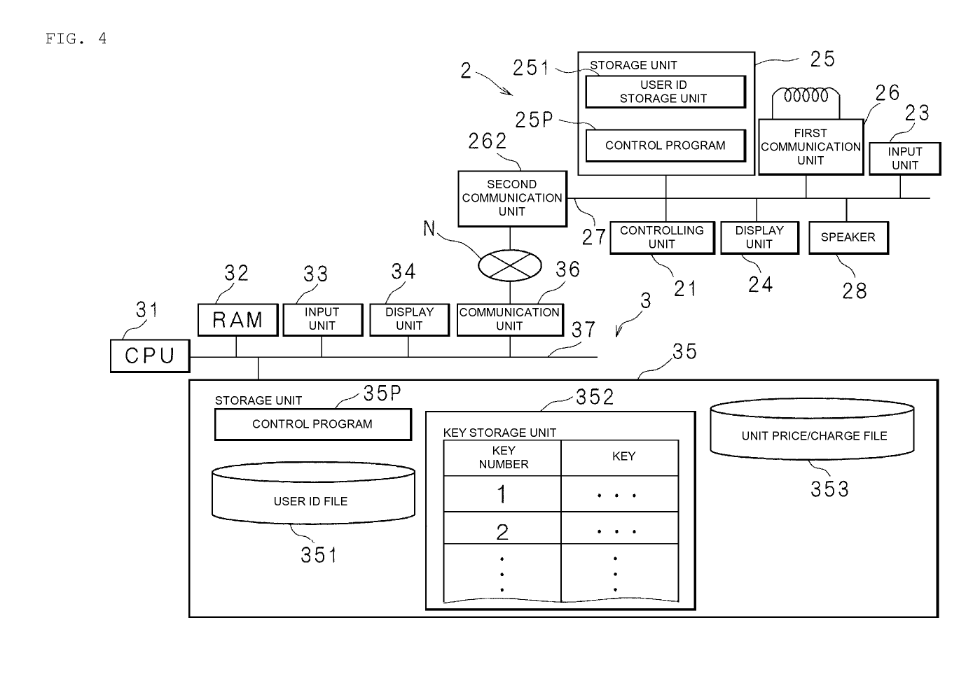

FIG. 4 is a block diagram showing a hardware configuration of the reader 2 and decryptor 3. The discussion below describes an example wherein the decryptor 3 is a server computer 3 which is connected to a communication network N, such as the Internet. The reader 2 includes a controlling unit 21, an input unit 23, a display unit 24, a speaker 28, a first communication unit 26, a storage unit 25 and a second communication unit 262. The controlling unit 21 is a logic circuit, or the like, which controls each hardware section, such as the storage unit 25 connected through a bus 27, in accordance with a control program 25P stored in the storage unit 25. The first communication unit 26 may be a coil or an RF circuit for wireless communications, and sends and receives information on a radio wave or magnetic field to and from the communication unit 16 of the wireless tag 1.

The storage unit 25 stores a user ID storage unit 251 and the control program 25P employing an EEPROM, FeRAM, ROM, hard disk, or the like. The display unit 24 may, be a liquid crystal display, for example, and displays information regarding the decrypted product code or regarding the reading restriction of the wireless tag 1. Like the display unit 24, the speaker 28 outputs a warnings sound regarding the reading restriction of the wireless tag 1. The second communication unit 262 sends and receives information to and from the server computer 3 in accordance with a protocol, such as HTTP (Hyper Text Transfer Protocol) employing a LAN card, a wireless LAN unit, a modem, or the like. The input unit 23 is a button, a keyboard, or the like, which outputs input information to the controlling unit 21. The input unit 23 and the display unit 24 may be integrated, like a touch-panel, for example.

The user ID storage unit 251 of the storage unit 25 stores user identification (hereinafter, referred to as “user ID”) for specifying a user who uses the wireless tag 1. This user ID is to identify each product carrier, the retailer A, and the retailer B, for example. The user ID storage unit 251 stores also a password in association with a user ID. Note that the user may also be identified in accordance with any other method. For example, the user ID may be a MAC (Media Access Control) address of the second communication unit 262 of the reader 2. The storage unit 35 of the server computer 3 stores a MAC addresses in association with a user.

If the reader 2 detects the wireless tag 1, the controlling unit 21 sends a request for outputting an encrypted product code to the wireless tag 1 through the first communication unit 26. As described above, if the number sent does not reach the upper limit number, the wireless tag 1 outputs a new encrypted product code and a corresponding key number to the first communication unit 26. The controlling unit 21 stores the key number and encrypted product code received by the first communication unit 26 in the storage unit 25. The controlling unit 21 outputs the received encrypted product code to the server computer 3 through the second communication unit 262. The controlling unit 21 reads the user ID and password stored in the user ID storage unit 251 and outputs the read information to the server computer 3 through the second communication unit 262, simultaneously with, before or after the sending of the key number and encrypted product code.

The server computer 3 decrypts the encrypted product code and outputs the decrypted product code to the reader 2, in accordance with a process as will be described later. The second communication unit 262 receives the decrypted product code from the server computer 3. The controlling unit 21 stores the product code received by the second communication unit 262 in the storage unit 25, or outputs the product code received by the second communication unit 262 onto the display unit 24. The display unit 24 displays the decrypted product code.

On the contrary, if the number sent does not reach the upper limit number, the wireless tag 1 outputs an end code to the first communication unit 26. Upon reception of the end code, the first communication unit 26 outputs the received end code to the controlling unit 21. Upon reception of the end code, the controlling unit 21 outputs information indicating that all of the encrypted product codes of the wireless tags 1 have been used, to the display unit 24 or the speaker 28. For example, the controlling unit 21 reads a message “This wireless tag is not available. Please inquire of the manufacturer.” which is stored in the storage unit 25. The unit 21 outputs the read message to the display unit 24. Alternatively, the controlling unit 21 outputs an abnormal signal to the speaker 28. Then, the speaker 28 outputs the abnormal signal. As a result, the user can notice that the wireless tag 1 is not available.

Descriptions will now be made to the contents of the server computer 3 as the decryptor 3. The server computer 3 includes a CPU 31 as a controlling unit, a RAM 32, an input unit 33, a display unit 34, a communication unit 36 and a storage unit 35. The CPU 31 is connected to each hardware section of the server computer 3 through a bus 37. The CPU 31 controls each hardware section of the server computer 3, and executes various software functions in accordance with a control program 35P stored in the storage unit 35.

For the display unit 34, a liquid crystal display, or the like may be used. For the input unit 33, a keyboard, a mouse, or the like may be used. For the communication unit 36, a modem, a LAN card, or the like may be used. The communication unit 36 sends and receives various data to and from the reader 2 through the communication network N, in response to a command from the CPU 31. The storage unit 35 may be, for example, a hard disk. The storage unit 35 stores the above-described control program 35P, a user ID file 351, a key storage unit 352 and a unit price/charge (for using the tag) file 353. In this embodiment, the storage unit 35 stores the user ID file 351, the key storage unit 352 and the unit price/charge file 353 separately. However, the data configuration is not limited to this, and can arbitrarily be set. A database server, not shown in drawings, may store the user ID file 351, the key storage unit 352 or the unit price/charge file 353 and the CPU 31 may send and receive information to and from the database server through the communication network N, as needed. The user ID file 35, the key storage unit 352 and the unit price/charge file 353 will more specifically be described later.

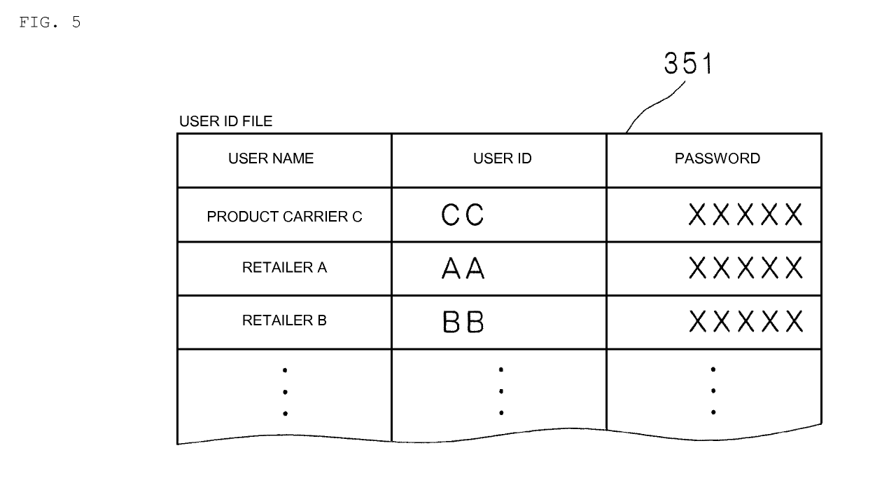

Upon reception of a user ID, a password, a key number and an encrypted product code from the reader 2, the communication unit 36 outputs the received user ID, password, key number and encrypted product code to the CPU 31. The CPU 31 refers the user ID file 351 so as to authenticate the received user ID and password. FIG. 5 is an explanatory diagram showing a record layout for the user ID file 351. The user ID file 351 includes fields of “user name”, “user ID” and “password”.

The names of users who use the wireless tag 1 are stored in the field of “user name”. In the example of FIG. 5, “product carrier C”, “retailer A”, and the like are stored in the fields of “user name”. The user IDs for identifying the users are stored in the fields of “user ID” in association with user names. For example, the user ID of “product carrier C” is “CC”. As described above, when a MAC address unique to a device of the reader 2 is used, a plurality of user IDs can be stored in association with one user name. For example, when “product carrier C” uses a plurality of readers 2, MAC addresses of the second communication units 262, in the respective readers 2, are stored.

The field of “password” stores passwords in association with the user names and user IDs. The CPU 31 determines whether the user ID and password output from the reader 2 match the user ID and password stored in the user ID file 351. When determined that those user IDs and passwords are the same, the CPU 31 refers the key storage unit 352 so as to implement a decrypting process based on the output key number and encrypted product code. As shown in FIG. 4, the key storage unit 352 stores a key for decrypting an encrypted product code in association with a key number. Note that as encryption scheme or decryption scheme, a common key encryption scheme, a public key encryption scheme or the like can be used.

The CPU 31 reads a corresponding key out of the key storage unit 352, based on the output key number. The CPU 31 decrypts the encrypted product code using the read key. The CPU 31 outputs the decrypted product code to the communication unit 36. The communication unit 36 outputs the decrypted product code to the reader 2. As described above, the reader 2 outputs the decrypted product code to the display unit 24 or the like.

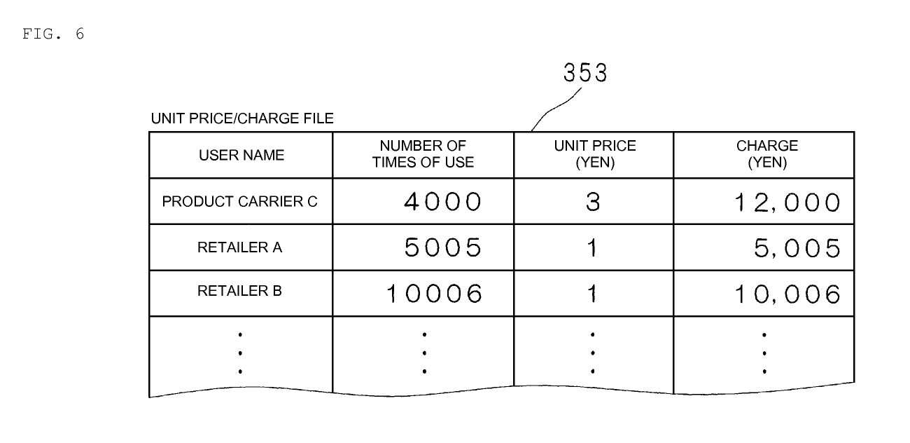

When the user ID is received, or every time the decrypted product code is sent to the reader 2 upon complete decrypting, the CPU 31 counts the number of times of use. The CPU 31 multiplies the number of times of use to the unit price so as to calculate the charge for using the tag. FIG. 6 is an explanatory diagram showing a record layout for the “unit price/charge file” 353. The unit price/charge file 353 includes fields of “user name”, “number of times of use”, “unit price” and “charge”.

The field of “number of times of use” stores the number of times the user ID has been received by the communication unit 36 in association with each user name. Every time the reader 2 sends the user ID together with the encrypted product code and the communication unit 36 receives the user ID with the encrypted product code, the CPU 31 reads the user name corresponding to the user ID out of the user ID file 351. The CPU 31 increments the number of times stored in the field of “number of times of use” corresponding to the read user. In the example of FIG. 6, it can be seen that the “product carrier C” has already decrypted the encrypted product code four thousand times, and “retailer A” has already decrypted the encrypted product code five thousand and five times.

The charge per use is stored in the field of “unit price” in association with user name. This unit price can be updated by the manager inputting an appropriate value through the input unit 33. For example, the unit price for the “product carrier C” is three yen, while the unit price for “retailer A” is one yen. The charge to be charged to each user is stored in the field of “charge”. The CPU 31 multiples the “number of times of use” to the “unit price” so as to obtain the “charge”, and stores the obtained “charge” in the field. For example, the “charge” for “product carrier C” is obtained by multiplying the “number of times of use” (4000) by the “unit price” (three yen), thereby obtaining a resultant value of 12,000 yen.

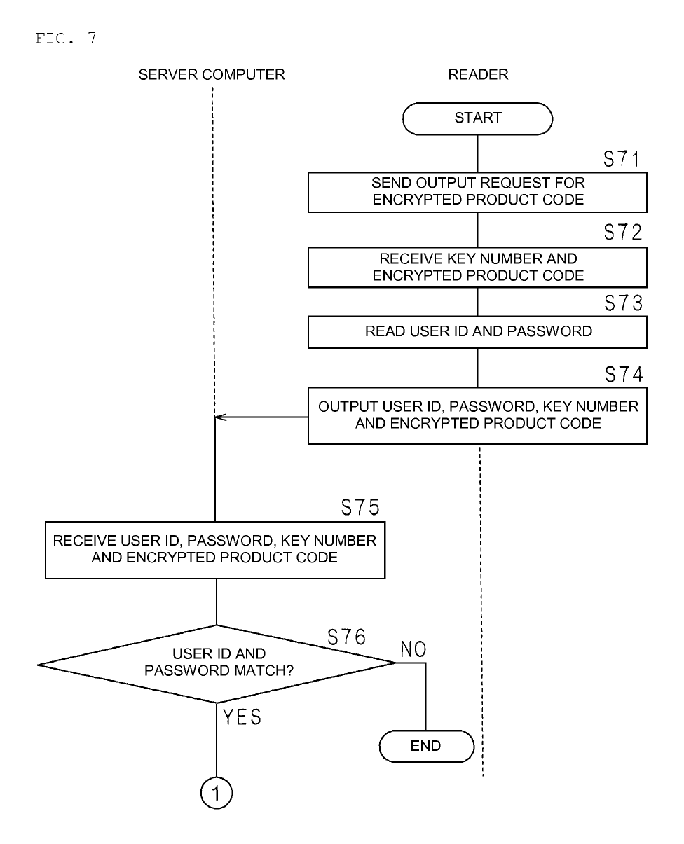

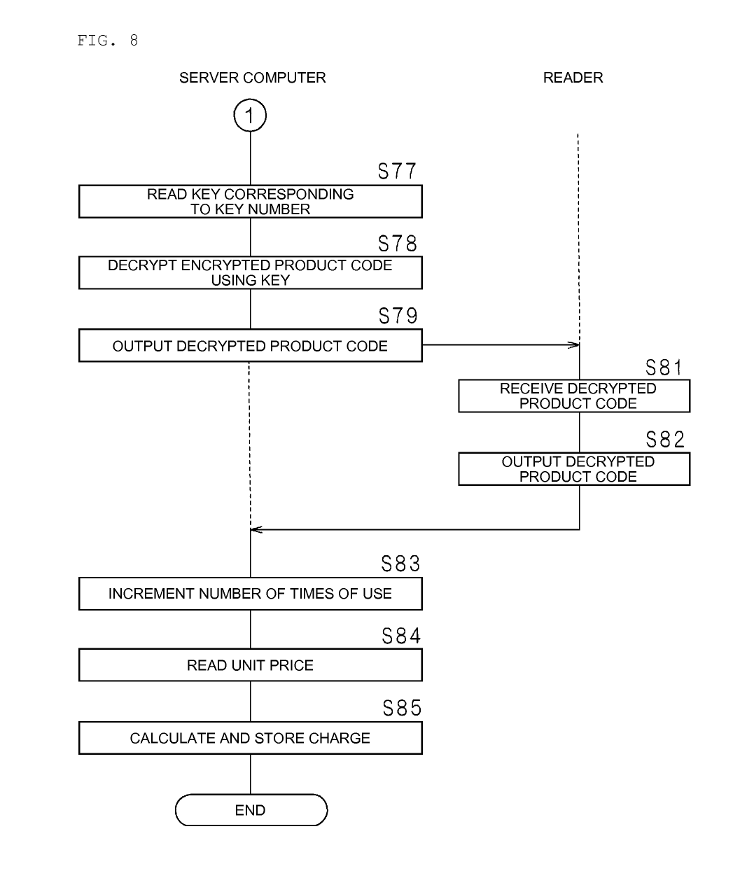

FIGS. 7 and 8 are flowcharts showing a sending/receiving process between the reader 2 and the server computer 3. The controlling unit 21 of the reader 2 sends a request for outputting an encrypted product code to the wireless tag 1 through the first communication unit 26 (Step S71). The first communication unit 26 receives a key number and encrypted product code output from the wireless tag 1 (Step S72), and outputs them to the controlling unit 21. The controlling unit 21 reads the user ID and password stored in the user ID storage unit 251 (Step S73), and outputs the read user ID and the password, and the output key number and the encrypted product code to the server computer 3 through the second communication unit 262 (Step S74).

The communication unit 36 of the server computer 3 receives the user ID, password, key number and encrypted product code (Step S75), and the CPU 31 stores the received user ID, password, key number and encrypted product code into the storage unit 35. The CPU 31 determines whether the received user ID and password match the user ID and password stored in the user ID file 351 (Step S76). When determined that the received user ID and password does not match the user ID and password stored in the user ID file 351 (No in Step S76), the CPU 31 recognizes that it is an unauthorized access request, and ends the process.

When determined that the received user ID and password match the user ID and password stored in the user ID file 351 (YES in Step S76), the CPU 31 reads a corresponding key out of the key storage unit 352 based on the received key number (Step S77). The CPU 31 decrypts the received encrypted product code using the read key (Step S78). The CPU 31 outputs the decrypted product code to the reader 2 through the communication unit 36 (Step S79).

The communication unit 262 of the reader 2 receives the decrypted product code output from the server computer 3 (Step S81). The controlling unit 21 of the reader 2 outputs the decrypted product code to the display unit 24 (Step S82). The CPU 31 of the server computer 3 reads the user name corresponding to the user ID authenticated in Step S76 out of the user ID file 351. The CPU 31 increments the “number of times of use” in the field stored in the unit price/charge file 353, in association with the read user name (Step S83). The CPU 31 reads the unit price corresponding to the user name out of the unit price/charge file 353 (Step S84). The CPU 31 multiplies the number of times of use, which has been incremented in Step S83, to the read unit price so as to calculate the charge, and stores the obtained charge in the field of “charge” of the unit price/charge file 353 in association with the user name (Step S85).

### Second Embodiment

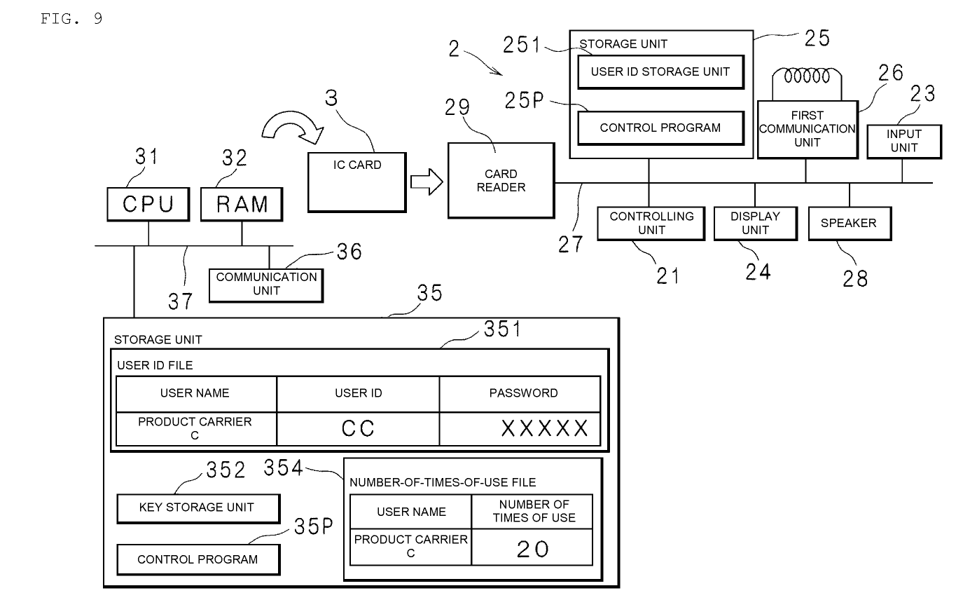

In a first embodiment, the functions of the decryptor 3 have been realized using the server computer 3. However, the functions can be realized using an IC card. FIG. 9 is a block diagram showing a hardware configuration of the reader 2 and the decryptor 3 according to a second embodiment. In this embodiment, descriptions will now be made to the case of using the IC card 3 as the decryptor 3. In addition to the functions of the first embodiment, the reader 2 has a card reader 29 which reads information of the IC card 3 and writes information onto the IC card 3. Necessary information can be input and output between the IC card 3 and the reader 2 by inserting the IC card 3 into the card reader 29. Note that the reading and writing of the IC card may be of a non-contact type using an RFID tag.

The IC card 3 has been distributed in advance to each user in order to implement the decrypting process and a process for counting the number of times of use. The card 3 is a tamper resistant card which can prevent unauthorized tampering. The IC card 3 includes the CPU 31 as a controlling unit, the RAM 32, the communication unit 36 and the storage unit 35. Each of the units is connected with each other through the bus 37. The CPU 31 executes processes of the IC card 3 in accordance with the control program 35P stored in the storage unit 35.

The communication unit 36 is an interface circuit which sends and receives information to and from the card reader 29. The storage unit 35 stores the above-described control program 35P, the user ID file 351, the key storage unit 352 and a number-of-times-of-use file 354, using an EEPROM, for example. The user ID file 351 stores user names using the IC card 3, user IDs and passwords. In this embodiment, the IC card 3 is distributed to the “product carrier C”. The user ID file 351 stores the “product carrier C” as a user name, also stores “CC” as a user ID and a password corresponding to the user ID “CC”.

The key storage unit 352 has already been described in the first embodiment. Counting the number of times of use and calculating the charge can be performed in the same manner as the first embodiment. In this embodiment, however descriptions will be made to the IC card 3 that only counts the number of uses. The number-of-times-of-use file 354 stores the number of times of use in association with each user name. The example of FIG. 9 shows that the “product carrier C” has implemented the decrypting process twenty times, using the IC card 3.

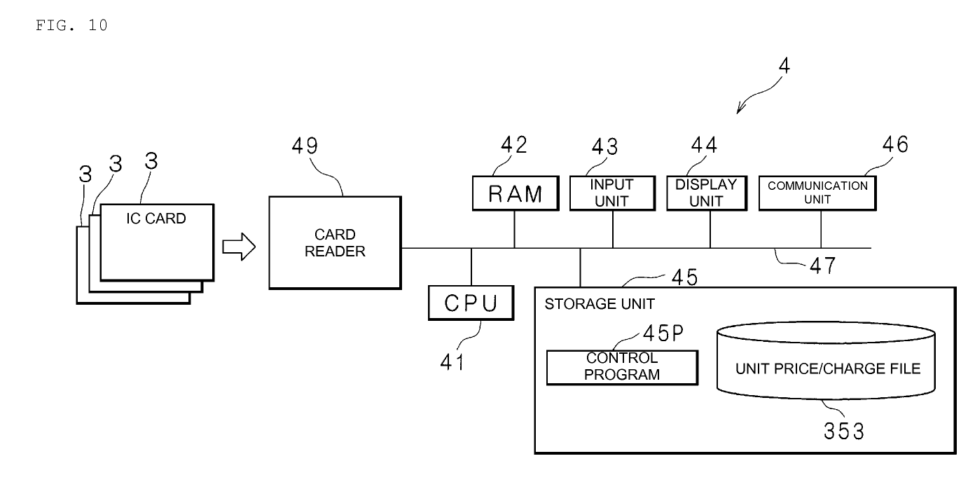

FIG. 10 is a block diagram showing a hardware configuration of an information processor. In FIG. 10, a reference numeral 4 identifies an information processor, which is a personal computer, for example. The discussion below describes an information processor 4 as a personal computer 4. The personal computer calculates the charge for using the tag. The personal computer 4 includes a CPU 41 as a controlling unit, a RAM 42, an input unit 43, a display unit 44, a communication unit 46, a storage unit 45 and a card reader 49. The CPU 41 is connected to each hardware section of the personal computer 4 through a bus 47. The CPU 41 controls each hardware section, and executes various software functions in accordance with a control program 45P stored in the storage unit 45.

As the display unit 44, a liquid crystal display or the like may be used, for example. As the input unit 43, a keyboard, a mouse, or the like may be used. The communication unit 46 includes, for example, a modem or a LAN card. The storage unit 45 is a hard disk, for example. The storage unit 45 stores the above-described control program 45P and the unit price/charge file 353. The unit price/charge file 353 has the same configuration as that described in the first embodiment. When the IC card 3 is inserted into the card reader 49 and a user name and the number of times of use are output in response to a command of the CPU 31 of the IC card 3, the CPU 41 stores the user name and the number of times of use in the unit price/charge file 353. The manager collects the IC cards 3 which store the user names and the number of times of use once a month, for example. By inserting all IC cards 3 into the card reader 49 of the personal computer 4, the manager can obtain the total number of times of use and the charge obtained by multiplying the unit price by the total number of times of use, in association with each user.

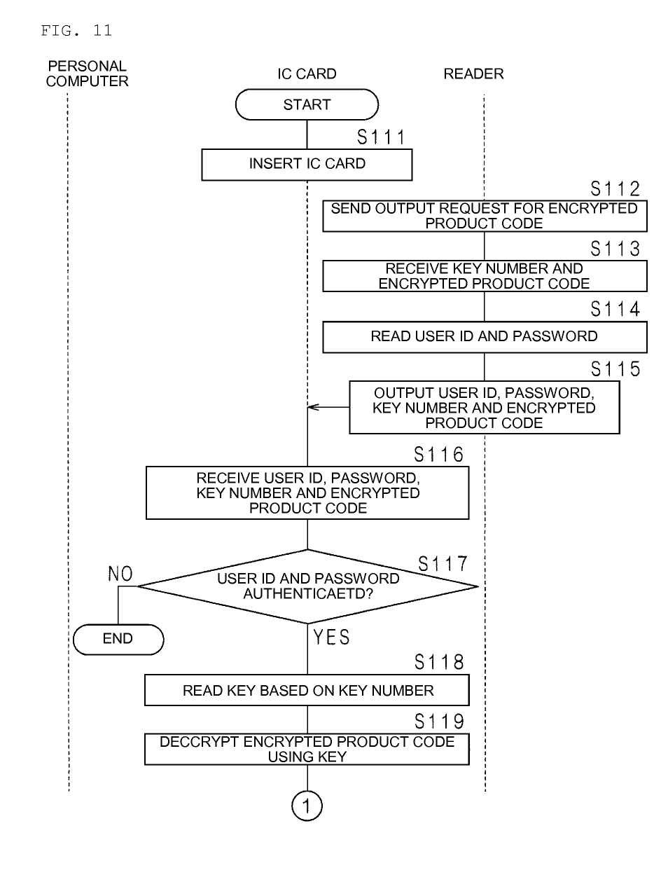

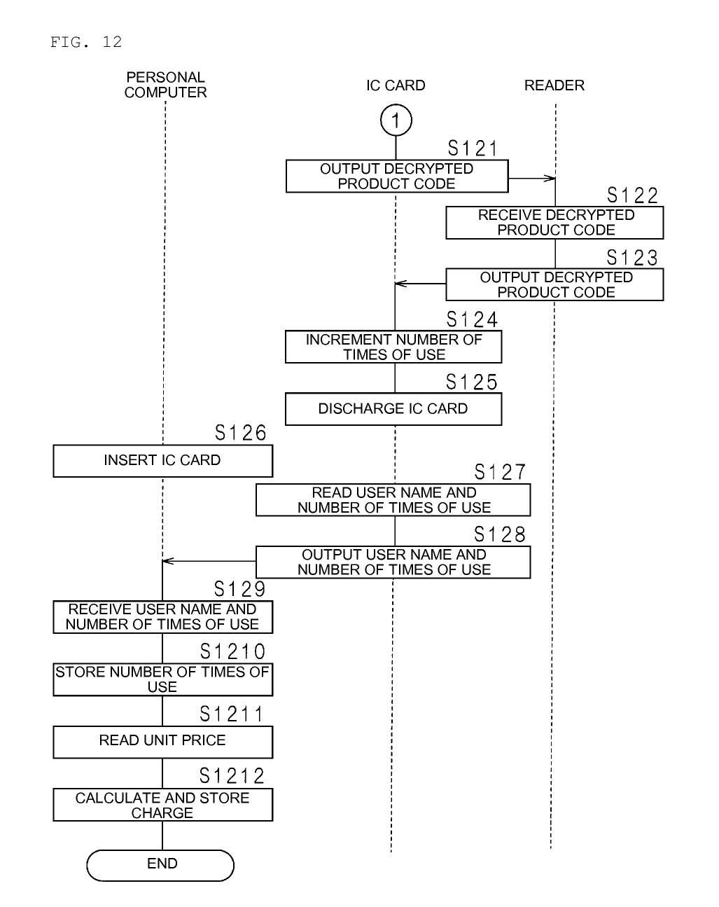

FIGS. 11 and 12 are flowcharts showing a procedure of a decrypting process and a procedure of a counting process, according to the second embodiment. The IC card 3 distributed to each user is inserted into the card reader 29 of the reader 2 (Step S111). The controlling unit 21 of the reader 2 sends a request for outputting an encrypted product code to the wireless tag 1 through the first communication unit 26 (Step S112). The first communication unit 26 receives the key number and encrypted product code output from the wireless tag 1 (Step S113), and outputs the received information to the controlling unit 21. The controlling unit 21 reads the user ID and password stored in the user ID storage unit 251 (Step S114), and outputs the read user ID and password and also the output key number and encrypted product code to the IC card 3 through the card reader 29 (Step S115).

The communication unit 36 of the IC card 3 receives the user ID, the password, the key number and the encrypted product code (Step S116), and the CPU 31 stores the received user ID, password, key number and encrypted product code in the storage unit 35. The CPU 31 determines whether the received user ID and password match the user ID and password stored in the user ID file 351 (Step S117). When determined that the received user ID and password does not match the user ID and password stored in the user ID file 351 (NO in Step S117), the CPU 31 recognizes that it is an unauthorized access request, and ends the process.

When determined that the received user ID and password match the user ID and password stored in the user ID file 351 (YES in Step S117), the CPU 31 reads a corresponding key out of the key storage unit 352 based on the received key number (Step S118). The CPU 31 decrypts the received encrypted product code using the read key (Step S119). The CPU 31 outputs the decrypted product code to the reader 2 through the communication unit 36 (Step S121).

The card reader 29 of the reader 2 receives the decrypted product code output from the IC card 3 (Step S122). The controlling unit 21 of the reader 2 outputs the decrypted product code to the display unit (Step S123). The CPU 31 of the IC card 3 increments the number of times stored in the field of “number of times of use” stored in the number-of-times-of-use file 354 (Step S124). By repeating the above procedure, the decrypting process and the process for counting the number of times of use can be implemented every time the wireless tag 1 is used.

The manager discharges the IC card 3 from the card reader 29 at an appropriate timing (Step S125). The manager collects a plurality of IC cards 3, 3, 3 . . . used by the users respectively so as to calculate the charges for using the tag. The manager inserts the IC cards 3 into the card reader 49 of the personal computer 4 (Step S126). The CPU 31 of the personal computer 4 reads the user name and number of times of use out of the number-of-times-of-use file 354 (Step S127). The CPU 31 outputs the read user name and the number of times of use to the personal computer 4 through the communication unit 36 (Step S128).

The card reader 49 of the personal computer 4 receives the output user name and number of times of use (Step S129). The CPU 41 of the personal computer 4 stores the received number of times of use in association with the user name in the unit price/charge file 353 (Step S1210). When the plurality of IC cards 3 are distributed to one single user, the total number of times of use stored on each IC card can simply be stored in association with each single user. The CPU 41 reads the unit price corresponding to the user name out of the unit price/charge file 353 (Step S1211). The CPU 41 multiplies the number of times of use stored in Step S1210 by the read unit price so as to calculate the charge, and stores the obtained charge in the field of “charge” in the unit price/charge file 353 in association with the user name (Step S1212). By repeating the procedure of Step S126 to Step S1212 for the entire IC cards 3, the process for obtaining the number of times of use and calculating the charge for using the tag are completed.

The second embodiment has the configuration described above. Any other configurations and functions match those described in the first embodiment, and the same reference numerals are given to the corresponding sections and will not be specifically described here again.

### Third Embodiment

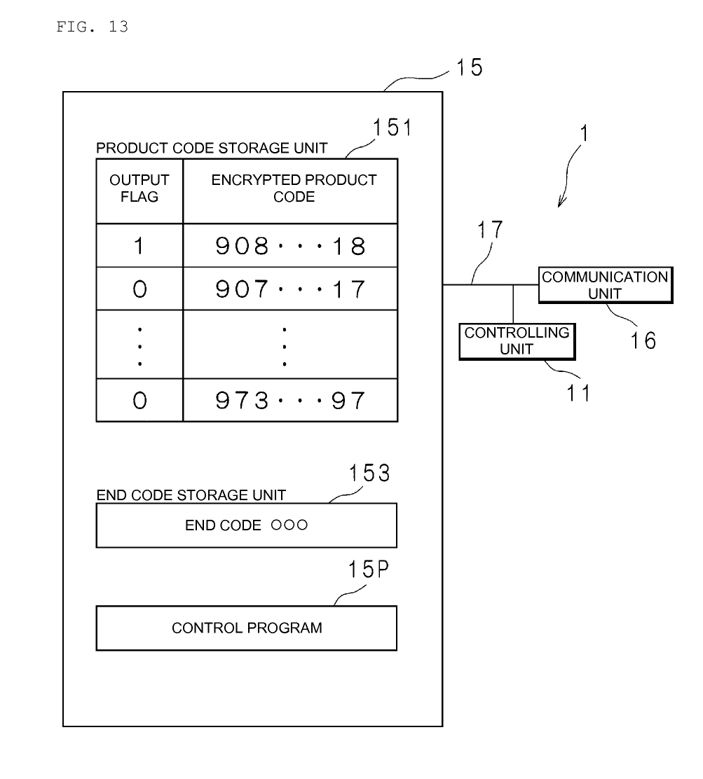

In the first and second embodiments, the descriptions have been made to the configuration that the wireless tag 1 stores the key number. However, it is not necessary that the wireless tag 1 stores the key number. In a third embodiment, descriptions will be made to the configuration that the wireless tag 1 does not store the key number. FIG. 13 is a block diagram showing a hardware configuration of the wireless tag 1 according to the third embodiment. In third embodiment, the storage unit 15 differs from that of the first embodiment. The storage unit 15 includes the product code storage unit 151 and the end code storage unit 153, and stores the control program 15P. Note that the storage unit 15 does not include the sending history storage unit 152 described in the first embodiment.

The product code storage unit 151 includes fields of “output flag” and “encrypted product code”. Like the first embodiment, the field of “encrypted product code” stores a predetermined number (e.g. 100) of unique encrypted product codes. In the field of “output flag”, the value “0” is set as an initial. At the time of the encrypted product code is output, the value “1” is set in the field of “output flag” in association with the encrypted product code. Upon reception of a request for outputting the encrypted product code from the reader 2, the controlling unit 11 reads an encrypted product code whose output flag is “0”, out of the encrypted product codes stored in the product code storage unit 151. The controlling unit 11 outputs the read encrypted product code to the reader 2 through the communication unit 16. Then, the controlling unit 11 updates the output flag corresponding to the output encrypted product code in the product code storage unit 151, from its initial value “0” to “1”.

The controlling unit 11 sends an encrypted product code whose output flag is “0”, but does not send an encrypted product code whose output flag is “1”. Thereby, the controlling unit 11 outputs only an encrypted product code that has not been output yet, out of the plurality of encrypted product codes. The encrypted product code may be read and output randomly, other than the order in the storage as long as the encrypted product code has “0” as its output flag.

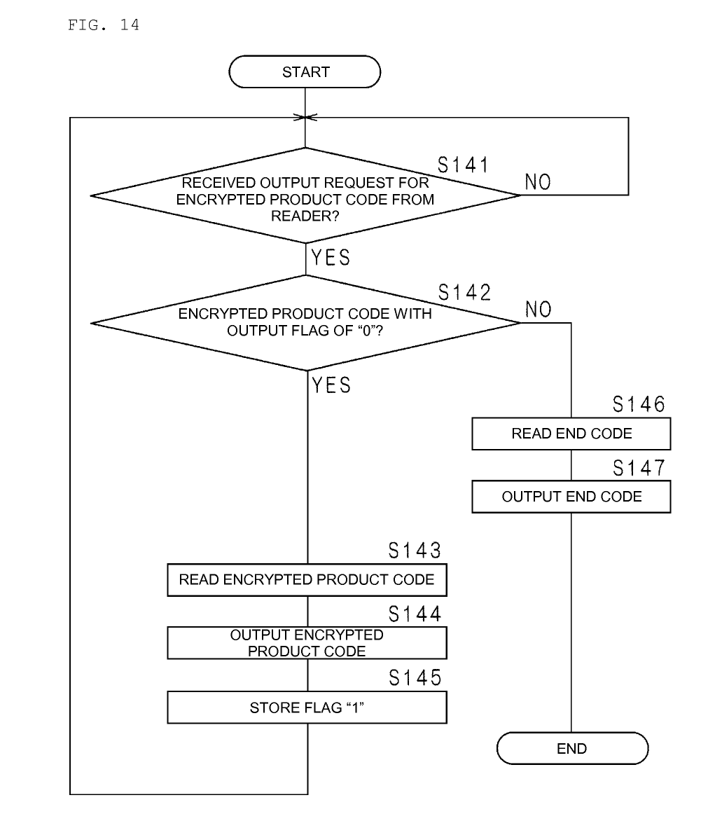

FIG. 14 is a flowchart showing a procedure of a process for outputting the encrypted product code of the wireless tag 1. The controlling unit 11 determines whether a request for outputting the encrypted product code has been received from the reader 2 (Step S141). When determined that the request for outputting the encrypted product code has not been received from the reader 2 (NO in Step S141), the controlling unit 11 waits until the request for outputting is received. On the contrary, when determined that the request for outputting the encrypted product code has been received from the reader 2 (YES in Step S141), the controlling unit 11 determines whether there is an encrypted product code, whose output flag is “0” in the field of “output flag” in the product code storage unit 151 (Step S142).

When determined that there is an encrypted product code, whose output flag is “0” (YES in Step S142), the controlling unit 11 reads an arbitrary encrypted product code, whose output flag is “0”, out of the product code storage unit 151 (Step S143). The controlling unit 11 outputs the read encrypted product code to the reader 2 through the communication unit 16 (Step S144). The controlling unit 11 sets the output flag in the product code storage unit 151, which corresponds to the encrypted product code output in Step S144, from “0” to “1” and stores the set output flag in the product code storage unit 151 (Step S145). Then, the controlling unit 11 moves to Step S141 and repeats the above procedure.

In Step S142, when determined that there is no encrypted product code whose output flag is “0” in the product code storage unit 151 (NO in Step S142), the controlling unit 11 reads the end code out of the end code storage unit 153 because all of the one hundred encrypted product codes have already been output (Step S146). The controlling unit 11 outputs the read end code to the reader 2 through the communication unit 16 (Step S147).

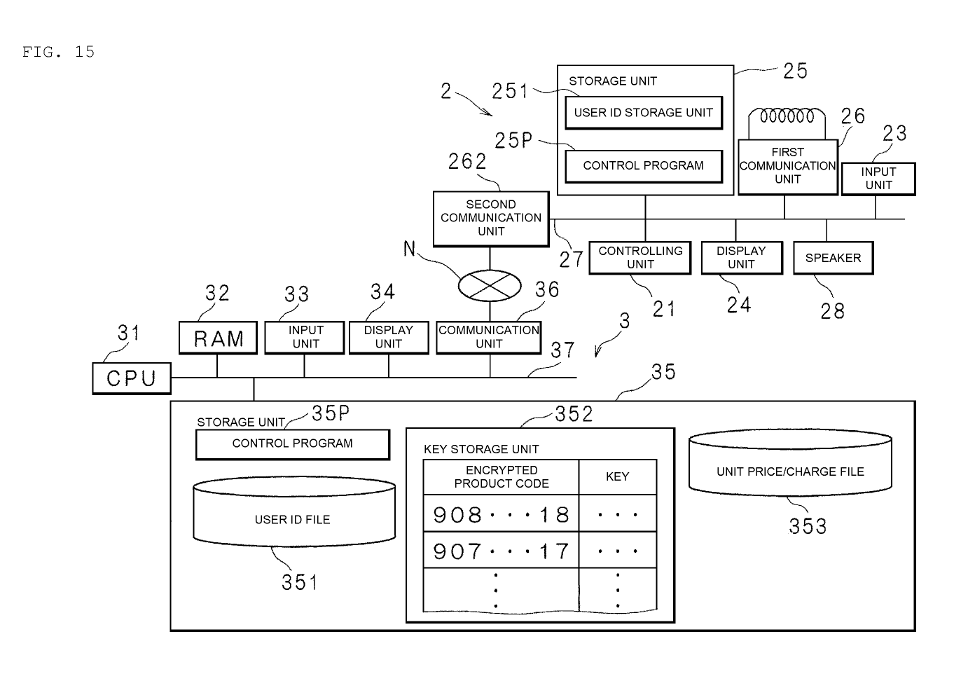

FIG. 15 is a block diagram showing a hardware configuration of the reader 2 and decryptor 3 according to the third embodiment. In the third embodiment, a record layout of the key storage unit 352 of the server computer differs from that of the first embodiment. The key storage unit 352 includes fields of “encrypted product code” and “key”. The key storage unit 352 stores keys for decrypting encrypted product codes in association with the encrypted product codes. The reader 2 does not output a key number to the server computer 3. The reader 2 outputs a user ID, a password and an encrypted product code to the server computer 3. The CPU 31 of the server computer 3 reads a key, corresponding to the encrypted product code received by the communication unit 36, out of the key storage unit 352. The CPU 31 decrypts the received encrypted product code using the read key. Then the CPU 31 outputs the decrypted product code to the reader 2 through the communication unit 36.

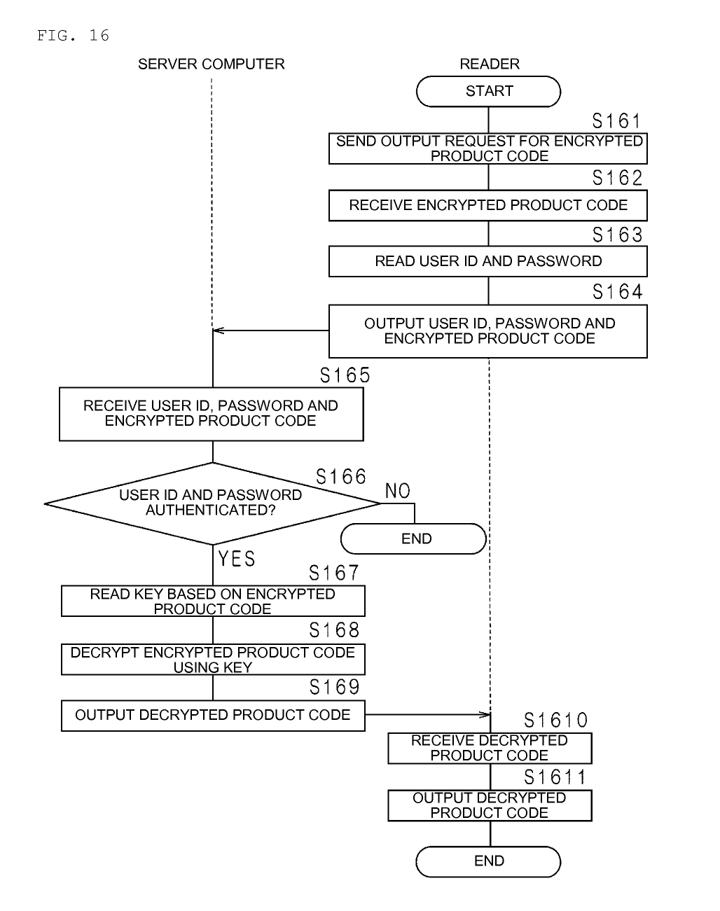

FIG. 16 is a flowchart showing a sending/receiving process between the reader 2 and the server computer 3. The controlling unit 21 of the reader 2 sends a request for outputting an encrypted product code to the wireless tag 1 through the first communication unit 26 (Step S161). The first communication unit 26 receives the encrypted product code output from the wireless tag 1 (Step S162). The first communication unit 26 outputs the received encrypted product code to the controlling unit 21. The controlling unit 21 reads the user ID and password stored in the user ID storage unit 251 (Step S163). The controlling unit 21 outputs the read user ID and password and the received encrypted product code to the server computer 3 through the second communication unit 262 (Step S164).

The communication unit 36 of the sever computer 3 receives the user ID, password and encrypted product code (Step S165). The CPU 31 stores the received user ID, password and encrypted product code in the storage unit 35. The CPU 31 determines whether the received user ID and password match the user ID and password stored in the user ID file 351 (Step S166). When determined that the received user ID and password does not match the user ID and password stored in the user ID file 351 (NO in Step S166), the CPU 31 recognizes that it is an unauthorized access request and ends the process.

When determined that the received user ID and password match the user ID and password stored in the user ID file 351 (YES in Step S166), the CPU 31 reads a corresponding key out of the key storage unit 352 based on the received encrypted product code (Step S167). The CPU 31 decrypts the received encrypted product code using the read key (Step S168). The CPU 31 outputs the decrypted product code to the reader 2 through the communication unit 36 (Step S169).

The communication unit 262 of the reader 2 receives the decrypted product code output from the server computer 3 (Step S1610). The controlling unit 21 of the reader 2 outputs the decrypted product code to the display unit 24 (Step S1611). The process for counting the number of times of use and the process for obtaining the charge, following the above described steps, is proceeded in the manner described above, thus will not be described again here. As described above, this embodiment, without using the key number, can be implemented to the first embodiment. Similarly, this embodiment, without using the key number, can be implemented to the second embodiment using the IC card 3.

The third embodiment has the configuration described above. Any other configurations and functions are the same as those described in the first and second embodiments, and the same reference numerals are given to the corresponding sections and will not be specifically described here again.

According to the embodiments, when a request for outputting identification is sent from the wireless tag reader, an identification, which has not been output yet, out of the identification stored in the storage unit is output by the controlling unit through the communication unit. When all the identifications stored in the storage unit are output, restricting means restricts the output of the encrypted identification stored in the storage unit, in accordance with the controlling unit. With this configuration, each of the plurality of encrypted identifications is output only once. As a result, even if a third party gets the encrypted identification and decrypted identification of the wireless tag, the same encrypted identification is not output. Thus, the wireless tag can be prevented from illegal diversion and prevented from being used without paying the charge.

According to the embodiments, the wireless tag reader outputs the received encrypted identification and user identification for identifying the user of the wireless tag, to the decryptor. The decryptor receives the encrypted identification and user identification output from the wireless tag reader. The counting means of the decryptor counts the number of receiving the user identification and obtains the charge for using the tag. The decrypting means decrypts the encrypted identification, and outputs the decrypted identification to the wireless tag reader. The wireless tag reader receives the information, and outputs the received identification. Thereby, the charge for using the tag can be obtained in accordance with the number of times of use of the wireless tag. As a result, it is possible to charge for each user in accordance with the number of times of use of the wireless tag in cooperation with the functions of the above-described wireless tag, thereby it is possible to maintain fairness and further spread of the wireless tag.

According to the embodiments, the wireless tag reader outputs the received encrypted identification, the key number and the user identification for identifying the user of the wireless tag, to the decryptor. The decryptor receives the output information. The decryptor includes a key storage unit, which stores a key for decrypting, in association with the key number. The decrypting means decrypts the encrypted identification corresponding to the received key number, using the key corresponding to the key number and stored in the key storage unit and then, the decrypting means outputs the decrypted identification to the wireless tag reader. The wireless tag reader receives the identification, and outputs the received identification. As a result, the embodiments have advantages such that the wireless tag can be managed at a high security level.

What is claimed is:

1. A wireless tag comprising:
a storage part storing a plurality of encrypted identifications;
an output part outputting an identification which has not been output yet through a communication part, out of the identifications stored in the storage part, when a request for outputting identification which is externally transmitted is received; and
a restricting part restricting output of the encrypted identification stored in the storage part, when the output part has output all of the identifications stored in the storage part.

2. The wireless tag according to claim 1,
wherein
the restricting part outputs information other than the encrypted identification stored in the storage part through the communication part, when it is determined that all of the identifications stored in the storage part have been output.

3. The wireless tag according to claim 1 or 2,
wherein
the storage part stores the plurality of encrypted identifications in association with a plurality of key numbers; and
the output part outputs the key numbers and an identification stored in the storage part sequentially until a last key and an identification corresponding to the last key are output, through the communication part, when a request for outputting identification which is externally transmitted is received.

4. A wireless tag reader comprising:
a first receiving part receiving an encrypted identification output from a wireless tag;
a first output part outputting the encrypted identification received by the first receiving part and a user identification for identifying a user of the wireless tag;
a second receiving part receiving decrypted identification corresponding to the encrypted identification output by the first output part; and
a second output part outputting the decrypted identification received by the second receiving part.

5. A wireless tag reader according to claim 4,
wherein the first receiving part that further receives a key number output from a wireless tag;
wherein the first output part that further outputs the key number received by the first receiving part.

6. A wireless tag reader according to claim 4, further comprising:
a third output part outputting information indicating that all of the identifications of the wireless tag are used, when information other than the encrypted identification is received from the wireless tag.

7. A decryptor comprising:
a receiving part receiving encrypted identification and a user identification output from a tag reader;
a counting part counting a number of times of receiving user identifications;
a decrypting part decrypting the received encrypted identification; and
an output part outputting the identification decrypted by the decrypting part to the wireless tag reader.

8. A decryptor according to claim 7,
further comprising a key storage part storing a key for decrypting in association with the key number;
wherein the receiving part that further receives a key number output from a wireless tag reader;
wherein the decrypting part that decrypts the received encrypted identification in association with the key number,
using a key corresponding to the key number stored in the key storage part.

9. The decryptor according to claim 7, further comprising:
a unit price storage part storing a unit price for using the wireless tag; and
a charge calculating part calculating a charge by multiplying the number counted by the counting part to the unit price stored in the unit price storage part.

10. The decryptor according to claim 7, further comprising
a number-of-times outputting part, externally outputting: a number of times which has been counted by the counting part.

11. A storage medium stored with a program for operating a computer provided with a function for sending/receiving information to/from a wireless tag and for causing the computer to execute following processes of:
receiving an encrypted identification output from a wireless tag;
outputting the received encrypted identification and a user identification for identifying a user of the wireless tag;
receiving the decrypted identification corresponding to the output encrypted identification; and
outputting the received decrypted identification.

12. A storage medium according to claim 11,
wherein said process of receiving further receives a key number output from the wireless tag;
wherein said process of outputting further outputs the received key number.

13. A storage medium according to claim 11, the processes further comprising:
outputting information indicating that all of the identifications of the wireless tag are used, from the wireless tag when information other than the encrypted identification is received.

14. A storage medium stored with a program for operating a computer including a function for sending/receiving information to/from a wireless tag reader and for causing the computer to execute following processes of:
receiving encrypted identification and a user identification output from the wireless tag reader;
counting a number of times of receiving the user identifications;
decrypting the received encrypted identification; and
outputting the decrypted identification to the wireless tag reader.

15. A storage medium according to claim 14,
the process further comprising storing a key for decrypting in association with the key number in a storage part;
wherein said process of receiving further receives a key number output from the wireless tag reader;
wherein said process of decrypting decrypts the encrypted identification corresponding to the received key number, using the key corresponding to the key number stored in the key storage part.
